(19) United States
(12) Patent Application Publication
(10) Pub. No.: US 2016/0042840 A1
(43) Pub. Date: Feb. 11, 2016

(54) HIGH-SPEED DATA CABLE

(71) Applicant: Fraunhofer-Gesellschaft zur Foerderung der angewandten Forschung e.V., Munich (DE)

(72) Inventors: Conrad ZERNA, Nuernberg (DE); Hans ADEL, Stein (DE); Norbert SCHUHMANN, Erlangen (DE)

(21) Appl. No.: 14/923,285

(22) Filed: Oct. 26, 2015

Related U.S. Application Data
(63) Continuation of application No. PCT/EP2014/057481, filed on Apr. 14, 2014.

(30) Foreign Application Priority Data
Apr. 26, 2013 (DE) 102013207743.2
Nov. 19, 2013 (DE) 102013223584.4

(51) Int. Cl. H01B 11/04; H01B 7/02; H01B 11/18; H01B 11/00; H01B 3/30

(52) U.S. Cl. CPC H01B 11/04; H01B 11/002; H01B 3/30; H01B 11/18; H01B 7/02

(57) ABSTRACT

A high-speed data cable including at least one core pair, wherein a conductive shielding surrounds the cores and an insulating cable cladding encloses the conductive shielding. Each of the cores includes at least three electric conductors arranged in a twisted manner equidistantly to a longitudinal center axis of the respective core. On its outer surface, each of the conductors abuts on an insulating material, wherein the conductors of the respective core run separately from each other through the insulating material.

### CROSS-REFERENCE TO RELATED APPLICATIONS

This application is a continuation of copending International Application No. PCT/EP2014/057481, filed Apr. 14, 2014, which claims priority from German Application No. 10 2013 207 743.2, filed Apr. 26, 2013, and from German Application No. 10 2013 223 584.4, filed Nov. 19, 2013, which are each incorporated herein in its entirety by this reference thereto.

### BACKGROUND OF THE INVENTION

The present invention relates to a high-speed data cable.

Typical cables for these transmissions are, on the one hand, more or less stiff coaxial cables where an inner conductor is surrounded by a cylindrical outer conductor, and on the other hand, more flexible differential (balanced) cables where positive and negative cores run parallel to one another. The cores can be a solid single conductor or strands of several conductors. The cores are separated from one another by an insulating material. Within one strand, the conductors can be loosely adjoined or can be twisted. The differential pair can form a cable itself (with cladding) or can form a cable with several other differential pairs within a bundle.

Problems occur in particular at high data rates, such as due to higher ohmic conduction losses at higher frequencies and runtime differences (of the signals in the time domain) between the conductors of a core (multipath propagation). The same lead to reduced signal quality and, consequently to poorer transmission efficiency, i.e. lower data rate, lower range, higher necessitated transmitting power or the same.

### SUMMARY

According to a first embodiment, a high-speed data cable may have: at least one core pair, wherein a conductive shielding surrounds the cores; an insulating cable cladding encloses the conductive shielding; and each of the cores includes at least three electric conductors, wherein the conductors are arranged in a twisted manner equidistantly to a longitudinal center axis of the respective core; and each conductor abuts, on its outer surface, on at least one insulating material through which the conductors of the respective core run separately from one another.

Another embodiment may have the usage of an inventive high-speed data cable for balanced signal transmission.

According to another embodiment, a system may have: an inventive high-speed data cable, wherein the system is implemented to transmit a balanced signal via the high-speed data cable.

The core idea of the present invention is the finding that it is possible to enable high-frequency data transmission in a high-speed data cable in a more efficient manner, wherein in particular at high-frequencies a lower attenuation results. The high-speed data cable includes at least one core pair, wherein a conductive shielding surrounds the cores. The conductive shielding results in increased interference immunity of the cable, which allows, among others, faster data transmission. An insulating cable cladding encloses the conductive shielding and protects the cable, among others, from mechanical loads and corrosion. Each of the cores includes at least three electric conductors insulated from each other, wherein the conductors are arranged in a twisted manner equidistantly to a longitudinal center axis of the respective core. Due to the equidistant arrangement of the conductors to a longitudinal center axis, all conductors of a respective core have the same length. Due to the twisting, each conductor passes a possible interference source with a specific periodicity, or an alignment of the electric characteristics or environment of the individual conductors within the core is given due to the alternation of the positions of the conductors within the core. Thus, signal run time differences within each core of the cable are prevented due to conductors having different lengths. Different paths in this multipath propagation are electrically equal. Each of the conductors abuts on at least one insulating material on its outer surface. In the respective core, the conductors run separately from another. Due to the electric insulation of the conductors between one another a greater surface results, with the same amount of material of the electric conductors, and hence a greater effective cross-sectional area of the core at high frequencies, since in the same the current is guided primarily close to the surface (skin effect). The skin effect describes the confinement of the signal current to an ever smaller space (close to or at the conductor surface) at higher frequencies. Thus, the conductor cross-section available for current transport is effectively reduced, or the ohmic resistance increases with increasing frequencies. Thus, in particular at high frequencies, the skin effect results in high signal attenuation.

### BRIEF DESCRIPTION OF THE DRAWINGS

Embodiments of the present invention will be detailed subsequently referring to the appended drawings, in which:

FIG. 1 is a cross-section of an embodiment of a high-speed data cable;

FIG. 2 is a cross-section of an embodiment of a core of a high-speed data cable;

FIG. 3A is a perspective view of an embodiment of a high-speed data cable;

FIG. 3B is a further perspective view of an embodiment of a high-speed data cable;

FIG. 4 is a cross-section of a further embodiment of a core of a high-speed data cable with insulator core;

FIG. 5 is a cross-section of a further embodiment of a high-speed data cable;

FIG. 6A is a first schematic illustration of a star quad twisting of a high-speed data cable;

FIG. 6B is a second schematic illustration of a star quad twisting of a high-speed data cable; and

FIG. 6C is a third schematic illustration of a star quad twisting of a high-speed data cable.

### DETAILED DESCRIPTION OF THE INVENTION

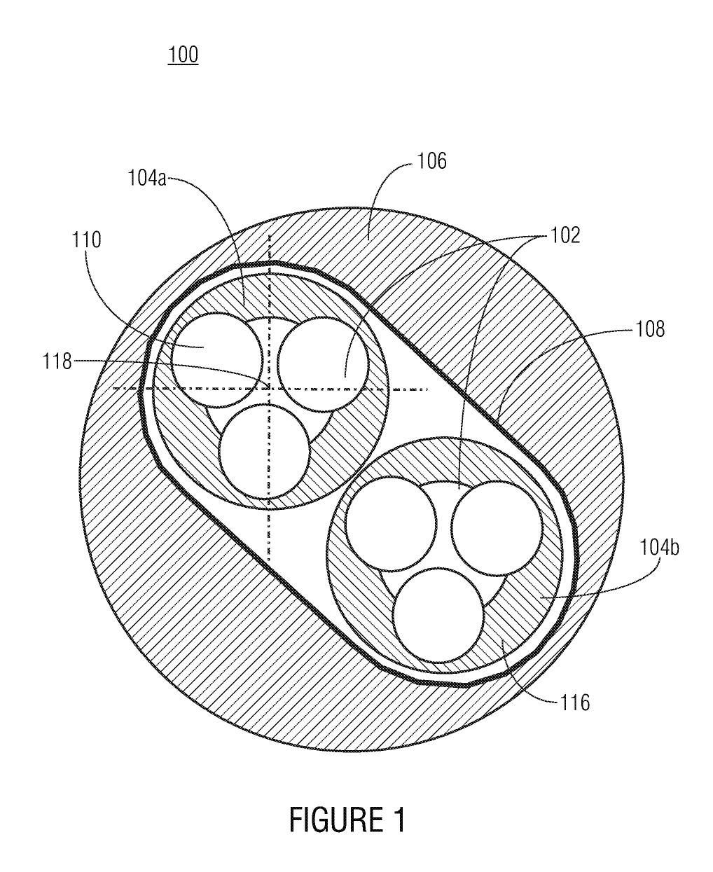

FIG. 1 shows a cross-section of an embodiment of a high-speed data cable 100, in the following also referred to as cable 100. The cable 100 includes at least one core pair 102. The same is exemplarily configured as a differential (balanced) cable, wherein the two cores 104a, 104b of the core pair 102 run parallel to one another in an axial direction. The two cores 104a, 104b of the core pair 102 have a differential push-pull impedance and a common mode impedance. The transmission of a useful signal is performed in that the difference between the two cores 104a, 104b represents the useful signal. Contrary thereto, the transmission in unbalanced cables is performed by a useful signal whose value changes with respect to a reference potential (ground). The useful signal can have a voltage potential and/or a current strength. In balanced signal transmission, the useful signal is less susceptible to spurious influences on a transmission path, in particular in the high-frequency range. At high frequencies, interferences can couple in easier, e.g. due to reduction of the shielding attenuation. Unbalanced cables cannot compensate this any further. In balanced cables, coupling-in of interferences is reduced in practice by attenuation unbalanced to ground. The attenuation unbalanced to ground indicates the deviation from the theoretical ideal equality of the positive and negative core. The spurious influences, for example by capacitive or inductive couplings on the transmission path are approximately equal during balanced signal transmission on both cores 104a, 104b, such that when forming the difference of the two signals of the cores 104a, 104b, the interference is almost canceled out.

A conductive shielding 108 surrounds the cores 104a, 104b in longitudinal direction and forms a Faraday cage around the cores 104a, 104b. The cores 104a, 104b can each be surrounded in pairs by a common conductive shielding 108. Alternatively, an individual shielding per core or a plurality of cores together would be possible. By the Faraday cage, the cores 104a, 104b are protected against outer electromagnetic alternating fields. This means that capacitive or inductive couplings of interferences on the cable 100 are prevented or at least reduced. Additionally, the Faraday cage of the shielding 108 prevents the cores 104a, 104b from emitting electromagnetic alternating fields, whereby further cores 104a, 104b of the cable 100 as well as the environment of the cable 100 are protected from electromagnetic emissions.

The conductive shield 108 can be produced of any conductive material, for example, the conductive shielding 108 is formed from metal-clad plastic foil or non-insulated metal wires. Further, the conductive shielding 108 can surround one core pair 102 each in any form, for example, wound or braided. Advantageously, the conductive shielding 108 is a wire mesh where individual metal wires not insulated with respect to one another are placed on top of one another, or a plastic clad metal foil that is wound around the cores 104a, 104b. The conductive shielding 108 is produced in dependence on the desired mechanic flexibility or stiffness and/or the necessitated electric shielding characteristic of the cable 100. The conductive shielding 108 can be produced as closed/solid cladding or as a combination of the above described elements.

The cores 104a, 104b can be twisted with one another or stranded, i.e. the cores 104a, 104b are twisted around a common axis in a longitudinal direction. Twisting the cores 104a, 104b supports the balanced characteristics of the cable 100. Interferences acting, for example, on the cores 104a, 104b from a specific direction are identically imprinted on both cores 104a, 104b of the core pair 102. In several core pairs 102, the individual core pairs 102 in the cable 100 can be twisted to a different extent. This reduces coupling-in of interferences of the core pairs 102 between the same.

An insulating cable cladding 106 encloses the conducting shielding 108 and forms the surface of the cable 100. The insulating cable cladding 106 can consist, for example, of polyvinylchloride (PVC), polypropylene (PP), polyethylene (PE) or another insulating material. The insulating cable cladding 106 encloses the conductive shielding 108 completely and prevents an electric connection between the conductive shielding 108 and the environment of the cable 100. Additionally, the insulating cable cladding 106 protects the cable 100 from chemical or mechanical influences which can result in damages of the cable 100. The insulating cable cladding 106, for example, can be extruded on the conductive shielding 108.

FIG. 1 shows a first implementation of a core 104a, 104b including three electric conductors 110. The conductors 110 can consist of any electrically conductive material. Advantageously, the electric conductors 110 are produced of metal, such as copper or aluminum or of copper or aluminum alloys. Copper and aluminum have a low specific electric resistance which is why they are particularly well suited as electric conductors. Additionally, aluminum has a low mass density and hence a low specific weight, and thus the weight of the cable 100 can be kept low.

The conductors 110 are arranged equdistantly (at the same distance) to a longitudinal center axis 118 of the respective core 104a, 104b. Thus, when considering the core cross-section, a circular arrangement of the conductors 110 around a center of the core 104a, 104b results, or the centers of the conductors 110 are arranged on a circle around the longitudinal center axis 118. In each core 104a, 104b, the conductors 110 are arranged in a twisted or warped manner around the longitudinal axis 118. Twisting of the conductors 110 increases the flexibility of the core 104a, 104b, i.e. the more the conductors 110 are twisted in the core 104a, 104b, the more flexible the core 104a, 104b can be bent, whereby small bending radii with the core 104a, 104b are possible without breaking the conductors 110 in the core 104a, 104b. Additionally, the same electrical (environmental) conditions are obtained for all conductors. However, stronger twisting also results in a greater effective conductor length with the same outer length of the cable. The individual conductors 110 of a core are each short-circuited at the ends of the cable. This can be performed, for example by soldering or crimping.

In further implementations of the core 104a, 104b, a plurality of conductors can be equidistantly arranged within the core 104a, 104b. Advantageously, one core includes 3 to 18 conductors 110.

At its outer surface, each conductor 110 abuts on at least one insulating material in which the conductors 110 of the respective core 104a, 104b run separately. The insulating material encloses the conductor 110 and prevents electric currents between the conductors 110. The insulating material between the conductors 110 reduces the influence of the skin effect. The skin effect occurs when a higher-frequency alternating current flows through an electric conductor. Here, the current density within the conductor is lower than at its surface. The displacement of the current to the surface increases with increasing frequency. This results in undesired attenuations of an electric cable. By the insulation of the individual conductors with respect to one another, the effective surface is increased with constant cross-section. Instead of a single conductor, several small electric conductors are available, which results in a greater surface. This results in an effectively higher conductor cross-section at high frequencies. This results in a lower attenuation in the respective core 104a, 104b.

As shown in FIG. 1, the conductors 110 of the core 104a, 104b can abut on different insulating materials. On the one hand, the conductors 110 are at least partly embedded in insulating material. The insulating material forms a core cladding 116 and consists, for example, of polyvinylchloride (PVC), polypropylene (PP), polyethylene (PE) or any other insulating material. Here, the materials can be solid materials or materials that are foamed up by a gas, for example air. The core cladding 116 keeps the cores 114a, 104b mechanically stable. The center of the core 104a, 104b can be free from insulating material, such that in the center, for example, air as insulating material abuts on the outer surface of the conductors. Air insulates the conductors 110 from one another and keeps the weight of the cores 104a, 104b low.

In the embodiment of FIG. 1, the conductors 110 of the core 104a, 104b are arranged at equal distances to the longitudinal center axis 118 of the core 104a, 104b. Thus, all conductors 110 of the core 104a, 104b have the same overall length. By the insulating material surrounding the conductors 110, exchange of the useful signal between the conductors 110 is impossible. In known cables, conductors can be twisted in several layers. Particularly in longer cables having insulated individual cores, this leads to run time differences of the useful signal, whereby the maximum signal transmission of the useful signal and hence the maximum transmission rate is restricted. In the equidistant arrangement of the conductors 110 to the longitudinal center axis 118 of the core 104a, 104b, all conductors 110 have the same length independent of the overall length of the cable 100, whereby no run time differences of the useful signals occur in the individual conductors 110.

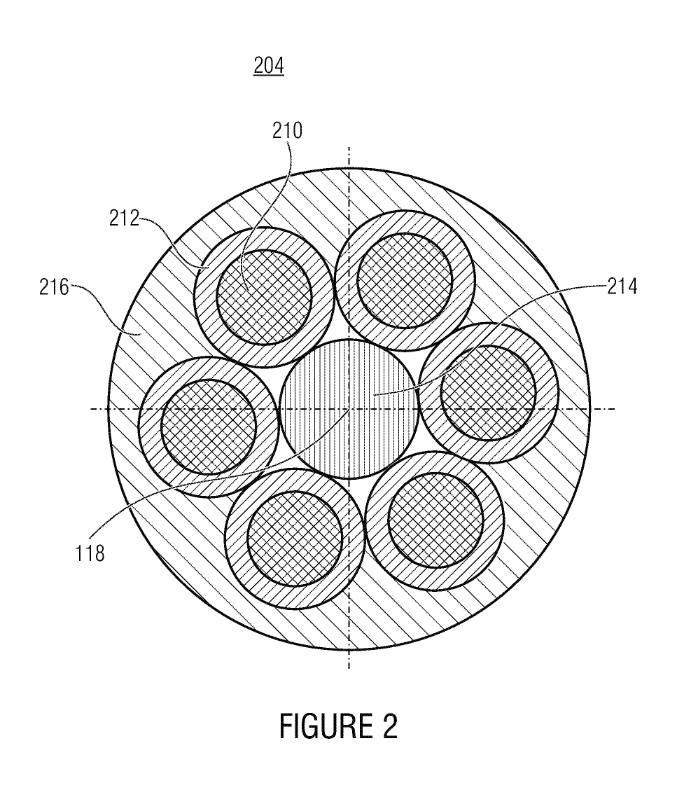

FIG. 2 shows a cross-section of a core 204 of a high-speed data cable according to a further embodiment of the present invention. The core 204 shown in FIG. 2 differs from the cores 104a, 104b in FIG. 1 among others by an insulating cover 212 which encloses each conductor 210 of the core 204 as insulating material. The insulating cover 212 is implemented to completely enclose each conductor 210 laterally, i.e., at the surface of the longitudinal side. By the insulating cover 212, the conductors 212 or the insulating cover 212 can abut on one another without short circuits occurring between the conductors 210. Thereby, a denser arrangement of the conductors 210 in the core 204 becomes possible, resulting, all-in-all, in a greater conductor cross-section for the useful signal. Additionally, the stability of the cable is increased by the abutting conductors 210.

The insulating cover 212 can, for example, be a resist layer or a plastic as used, for example, for the core or cable cladding. The advantage of a resist layer is that a thin-walled and inexpensive insulating cover 212 is possible, wherein the wall strength of the insulating cover 212 can be in a range of less than 10 μm to 80 μm. The ratio between wall strength of the insulating cover 212 and the radius of the conductor 210 is in the range 0.015 to 0.42. Since the voltage potentials between the conductors 210 of the core 202 are small, thin-walled insulation is sufficient. The breakdown strength of the resist layer insulation is, for example, in the range of 2 kV/mm. Thereby, 10 μm thin resist layers can be used, wherein the potential difference may be 40V. All conductors 210 of a core 202 carry the same signal, such that the potential differences remain very small, for example by local run time differences. The thin-walled insulation results in lower volume and weight of the conductors 210.

The conductors 210 having the insulating cover 212 are enclosed by the core cladding 216.

Further, the core 204 shown in FIG. 2 differs from the cores 104a, 104b shown in FIG. 1 by an isolator core 214 arranged along the longitudinal center axis 118 of the core 204 and on which the conductors 210 of the core 204 can abut. In this way, the conductors 210 are arranged in a circle around the isolator core 214. The isolator core 214 holds the conductors 210 or the conductor 210 with the insulating cover 212 at a specific distance with respect to the longitudinal center axis 118 of the core 204, wherein the distance corresponds to the radius of the isolator core 214. The conductor centers are spaced apart from the longitudinal axis 118 of the core 204 by a distance radius of the isolator core 214+radius of the conductors 210 with insulating cover 212. In dependence on the intended stiffness of the core 204, the isolator core 214 can be made of a more or less flexible material.

In the arrangement shown in FIG. 2, the isolator core 214 in the center of the core 204 and the conductors 210 with insulating cover 212 arranged around the same have equal diameters. With the same diameter, the conductors 210 with insulating cover abut both on each other and on the isolator core 214. Also, different ratios between conductor diameter with insulating cover 212 and isolator core 214 can be selected. Advantageously, the diameters of the conductors 210 and the isolator core 214 are selected such that the conductors 210 cover the surface of the isolator core 214 once, i.e., the conductors 210 with the insulating cover 212 abut on the isolator core 214 as well as on each other. This characteristic keeps the arrangement mechanically stable. Here, this characteristic has to be considered in view of the practical tolerance conditions of production. Possibly, the diameter of the isolator core 214 can be selected slightly larger such that during stranding (if needed) the insulated conductors 210 press into the isolator core 214 and, thus, a closed arrangement of the conductors 210 around the isolator core 214 is formed. Here, the material of the isolator core 214 is advantageously softer than the material of the insulating cover 212. In the opposite case, the situation can occur that the conductors 210 are pressed against one another around a too small isolator core 214 and the insulating cover 212 is damaged.

The isolator core 214 (non-conductive core) and the planar coverage of the isolator core surface (core surface) with conductor 210 with insulating cover 212 ensures that all conductors 210 have the same length and, hence, run time differences of the useful signal are prevented.

Additionally, the isolator core 214 (non-conductor) inside the core 204 (arrangement) and the insulating cover 212 reduce the proximity effect. In electrical engineering, proximity effect relates to effect of current constriction or current displacement between two closely adjacent conductors under the influence of alternating currents due to the magnetic leakage between the same, caused by rectified currents in the conductors 210. Similar to the skin effect, the rectified current in the adjacent conductor has the urge to prevent current flow at the surface. The current is forced into a smaller cross-section. By keeping the adjacent conductor apart, its influence can be reduced.

The isolator core 214 is advantageously made of an insulating material which, hence, does not conduct electric current. Suitable materials for the isolator core 214 are, for example, plastics or rubber. In particular, the isolator core 214 is made of polypropylene, polyamide or polyethylene. Here, the material can be processed, for example, in a massive manner, in a formed manner or also as monofil.

Compared to known cables where the inside of the core also consists of a metallic conductor, apart from increasing the data rate, the weight of the cable is also reduced by replacing conductors 210 with non-conductors as isolator core 214.

The insulating cover 212 shown in FIG. 2 as well as the also shown isolator core 214 are two independent features and can also be transferred individually to the embodiment shown in FIG. 1 or further shown embodiments.

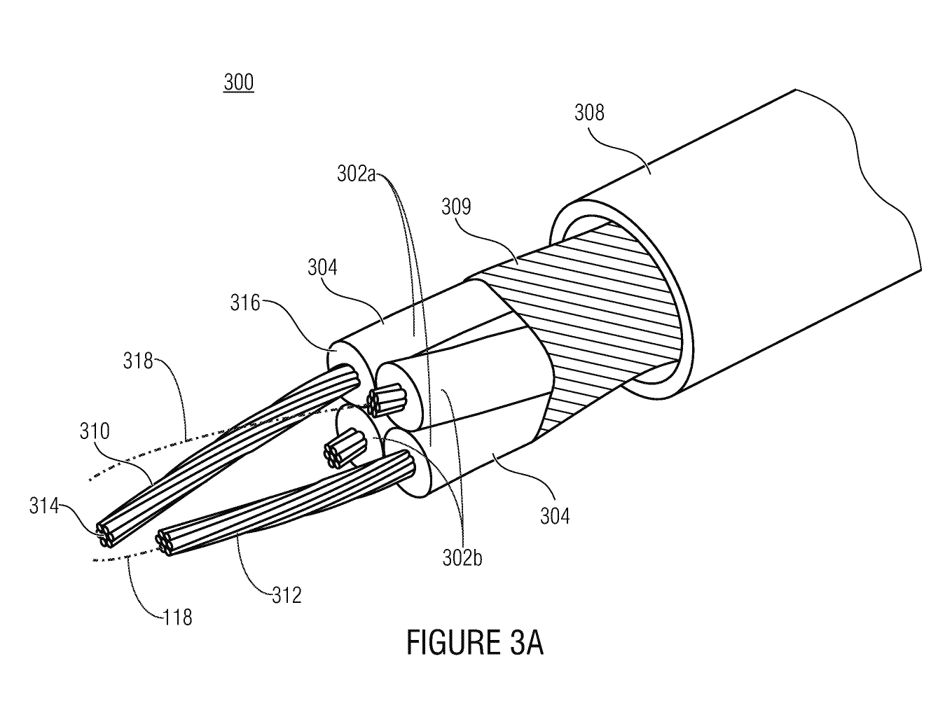

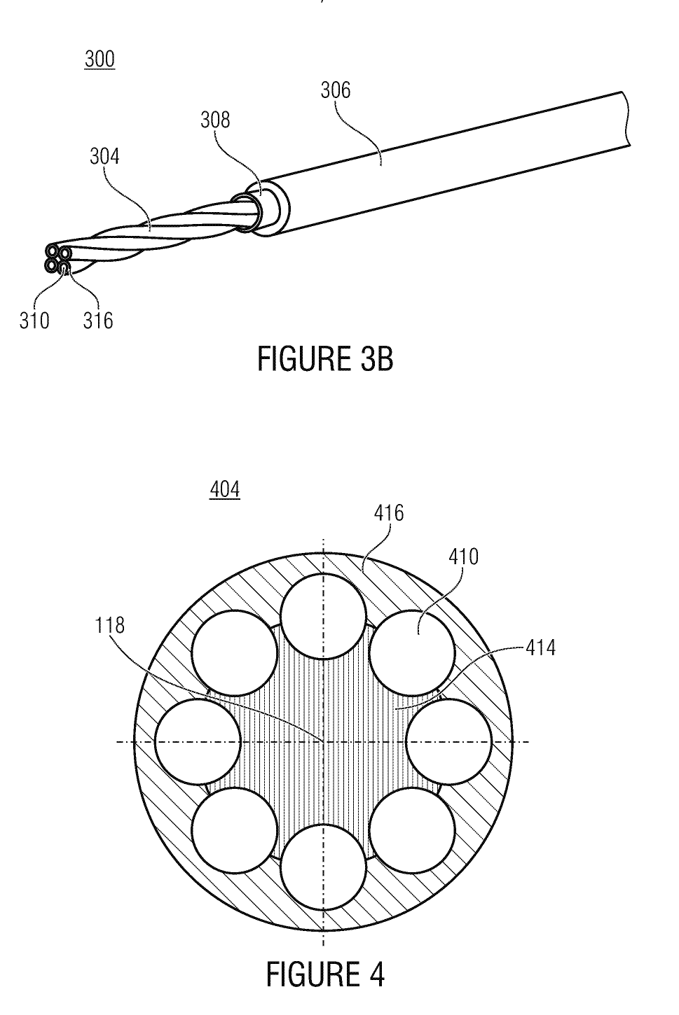

FIG. 3A shows a perspective view of a high-speed data cable 300 according to a further embodiment of the present invention. In the embodiment of FIG. 3, four cores 304 are shown. The cores 304 can be parallel to one another, can be twisted with each other or stranded or twisted as star quads. The star quad twisting represents a specific arrangement of cores 304 or of two differentiating core pairs 302a, 302b. The star quad can again form a cable 300 when combined with other core pairs and quads. In the star quad twisting, four cores 304 are stranded together, wherein then the cores 304 diagonally opposing each other are operated as differential pairs 302a and 302b. This has the advantage that due to the perpendicular core pairs 302a, 302b high crossover attenuation results between the core pairs. For keeping the cores 304 in their balanced position, additional support and stabilization elements can be used.

A stabilizing foil 309 surrounds the two core pairs 302a, 302b and keeps the same in their position. The stabilizing foil 309 can be made, for example, of elastic material which is applied closely to the cores or can be implemented as a shrink sleeve which is shrunk onto the cores 304. The stabilizing foil 309 can also have electrically conductive characteristics and, hence, form a conductive shielding 309 as described above, for example a metal-clad plastic foil.

A conductive shielding 308 can be arranged around the stabilizing foil 309, which is, for example, implemented as wire mesh. Further, the conductive shielding 308 can be surrounded by a cable cladding.

FIG. 3B shows a further embodiment of a high-speed data cable 300. In the embodiment, the high-speed data cable 300 includes four cores 304 each, which are surrounded by a conductive shielding 308. As shown in FIG. 3B, the cores 304 can be twisted. An insulating cable cladding 306 encloses the conductive shielding 308.

The individual electric conductors of one of the cores 304 are graphically illustrated as a surface due to the low resolution of FIG. 3B. The cores 304 are each enclosed by a core cladding 316.

As shown in the embodiment, the cores 304 can consist of six electrical conductors 310 each, which comprise an insulating cover 312 at their outer surfaces and are embedded in a core cladding 316. The conductors 310 are twisted around the isolator core 314 running along the longitudinal center axis 118, such that each individual conductor 310 runs, across the length of the cable 300, through the same relative positions with respect to the further other cores 304 and the conductive shielding 308. Only in this way equal electric ratios and hence the same electric parameters (in particular signal run times) of each conductor 310 are given.

Embodiments of the high-speed data cable 100, 300, 500, 600 can be used in any application with high data rates. Among others, these are all cables of the Ethernet Standard, LVDS cables, HDMI cables, TV transmission cables and also USB cables. Further fields of usage are possible. In high-frequency technology transmissions, it is generally necessitated to adapt the wave impedance of the cable 100, 300, 500, 600 to the source and terminating impedance of the transmission path. The wave impedance of the core pair 302a, 302b results from inductance per unit length and capacitance per unit length and is between 50Ω to 300Ω, advantageously, a wave impedance of the high-speed data cable 100, 300, 500, 600 is in the range between 75Ω to 160Ω (differential). However, the wave impedance can also be higher.

FIG. 4 shows a cross-section of a core 404 of a high-speed data cable according to a further embodiment of the present invention. The core 404 shown in FIG. 4 differs from the core 204 shown in FIG. 2 in that the eight conductors 410 arranged in regular intervals around the isolator core 414 comprise no insulating cover 212. The insulating material on which each conductor abuts is formed by the isolator core 414 as well as the core cladding. The conductors 410 are embedded in the isolator core 414 and are arranged equidistantly to the longitudinal center axis 118 of the core 404.

The isolator core 414 comprises recesses on its surface which are advantageously implemented according to the radius of the conductors 410. On the side facing away from the isolator core 414, the conductors 410 are molded or extruded into the core cladding 416. Thus, there is no electric connection between the conductors 410. By the embodiment shown in FIG. 4, cost and material for the isolating cover 212 can be saved.

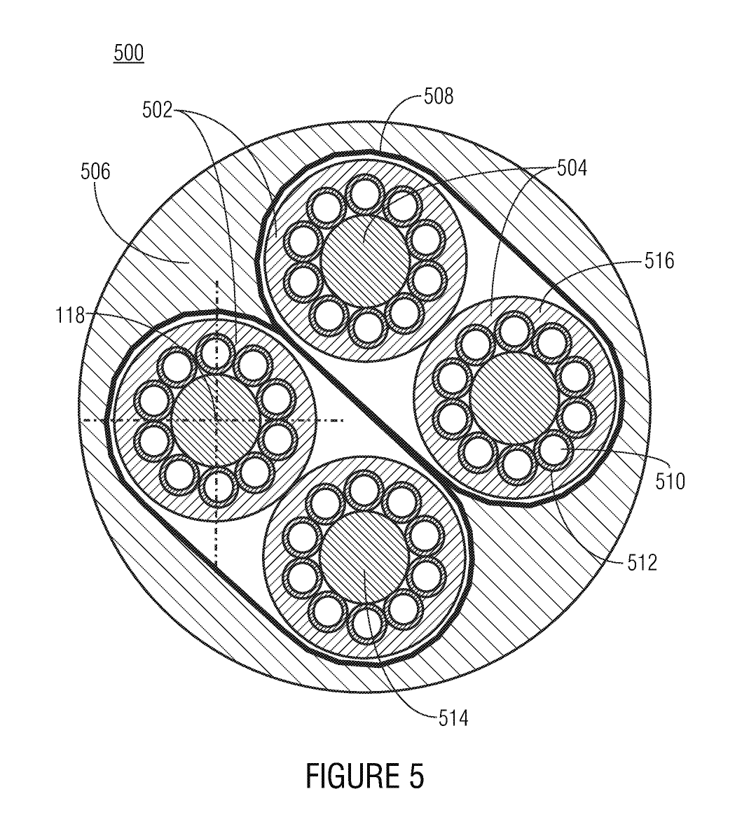

FIG. 5 shows a cross-section of a high-speed data cable 500 according to a further embodiment of the present invention. The embodiment shown in FIG. 5 comprises a plurality of core pairs 502, specifically two core pairs 502. The cores 504 are enclosed by the conductive shielding 508 in pairs, and an insulating core cladding 506 encloses the conductive shielding 508. Further, it is also possible, but not shown in FIG. 5, to surround the plurality of core pairs 502 additionally with a conductive shielding. For example, each core pair 502 can be enclosed by a metal-clad plastic foil and, additionally, the whole bundle of core pairs 502 by a conductive shielding or, for example, made up of wire mesh. Here, the two conductive shieldings 508 can have different shielding characteristics. Additionally, the wire mesh can improve the mechanical characteristics, such as abrasion resistance or bending strength of the cable.

The cores 504 have one isolator core 515 each, which is arranged along the longitudinal center axis 118 and around which ten conductors 510 with insulating cover 512 are arranged.

Due to the abutting conductors 510, the core cladding 516, as already shown in FIG. 2, is not applied directly on the isolator core 514. Depending on the production method and the used materials, the core cladding 506, in which the conductors 510 are embedded, can also abut on the isolator core 514.

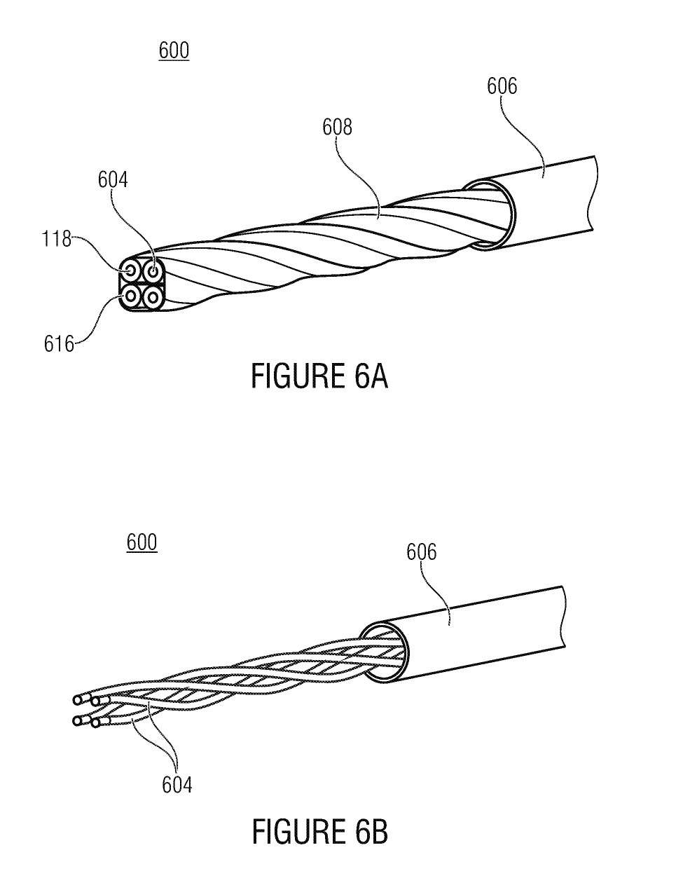

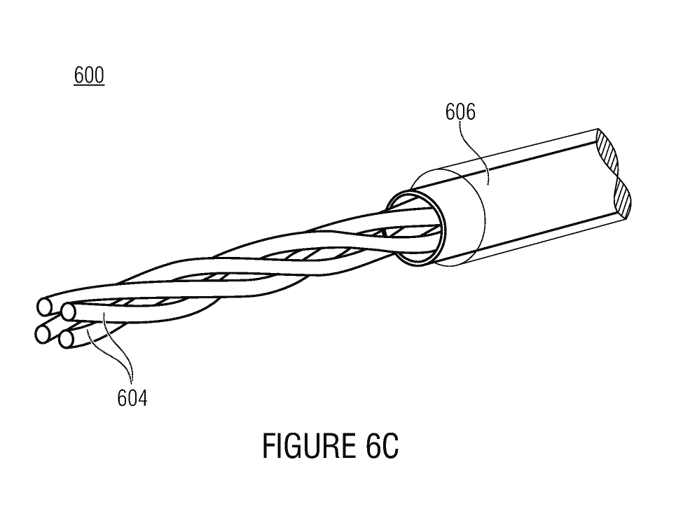

FIG. 6A shows a first schematic illustration of a star quad twisting. The conductors can be enclosed by an insulating cover. Further, the conductors are surrounded by the core cladding 616 and form a single core 604. An insulating core can be arranged in the center of the core 604. The cores 604 can be twisted as core pair 602 or star quad. The conductive shielding 608 surrounds the cores 604 and is enclosed be the insulating cable cladding 606.

FIGS. 6B and 6C show further schematic illustrations of a star quad twisting. FIGS. 6B and 6C show four cores 604 without core cladding. Thereby, the course of the individual cores 604 in a star quad twisting can be clearly seen. The cores 604 are partly covered by an insulating core cladding 606.

Due to the low resolution of FIGS. 6A, 6B and 6C, the individual electric conductors of one of the cores 604 are graphically illustrated as a plane.

The embodiments shown in the figures show the arrangement of electrically conductive and non-conductive elements in the cross-section of the core 604 of the cable 600. This new arrangement reduces the attenuation up to the GHz range and additionally reduces the weight of the cable 600. Both are obtained by further use of the materials that were conventionally used.

In other words, and by exemplarily using the reference numbers of FIG. 3, it can be said: For the electric transmission of high data rates across average distance, a cable 300 having great bandwidth or low attenuation at high frequencies is necessitated. For convenient handling, this cable 300 may not be too stiff or too heavy. Inevitably, these characteristics are also necessitated for the core(s) 304 of the cable 300. A core 304 refers to the conductor(s) 310 with insulation (insulating cover 312 and core cladding 316).

This disclosure describes a specific arrangement of the conductors 310 of a core 304 for reducing the attenuation with constant cross-section with a focus on high rate data transmission where signal run times are important. Further, the structure of the cable 300 for high rate data transmission using this core 304 is described. The objective is a cable 300 having a controlled wave resistance, low attenuation and small diameter.

In the core 304, advantageously, 3 to 18 resist-insulated massive conductors 310 are stranded around an isolator core 114 (non-conductive core).

The cable 300 allows reduced attenuation with constants diameter and materials (except the insulating cover 312 (additional resist layer) of the conductors 310 (single wires)). Also, “the top metal layer” of the conductors of a conventional core can be replaced by resist, i.e., the diameter of the conductor 310 can be reduced such that the previous outer diameter of the core 304 is maintained with the insulating cover 312. This reduces the weight per conductor. The overall outside diameter of the cable can stay the same. The cable 300 is particularly suitable for high rate data transmission in the gigahertz range where run time differences also have to be considered.

Embodiments of the high-speed data cable can be used for balanced signal transmission. Here, the high-speed data cable can be used, for example, in a system that is implemented to transmit a balanced signal via the high-speed data cable. Such a system comprising a high-speed data cable can be, for example, a network comprising a plurality of computers or a communication network, for example, for voice transmission. Here, in the broadest sense, computer means active network nodes, including at least a processer having a memory and to which also peripheral devices, such as sensors, control devices, monitors, cameras, etc. can be connected.

While some aspects have been described in the context of an apparatus, it is obvious that these aspects also represent a description of the respective method, such that a block or device of an apparatus can also be considered as respective method step or as a feature of a method step. Analogously, aspects that have been described in the context of or as a method step also represent a description of a respective block or detail or feature of a respective device. Some or all of the method steps can be performed by a hardware apparatus (or by using a hardware apparatus), such as a microprocessor, a programmable computer or an electronic circuit. In some embodiments, some or several of the most important method steps can be performed by such an apparatus.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. High-speed data cable comprising:
at least one core pair, wherein
a conductive shielding surrounds the cores;
an insulating cable cladding encloses the conductive shielding; and
each of the cores comprises at least three electric conductors, wherein
the conductors are arranged in a twisted manner equidistantly to a longitudinal center axis of the respective core; and
each conductor abuts, on its outer surface, on at least one insulating material through which the conductors of the respective core run separately from one another.

2. High-speed data cable according to claim 1, wherein, in each core, each conductor is enclosed on its outer surface by an insulating cover as insulating material.

3. High-speed data cable according to claim 2, wherein the insulating cover is a resist layer.

4. High-speed data cable according to claim 2, wherein, in each core, the conductors are at least partly embedded in insulating material.

5. High-speed data cable according to claim 1, wherein, in each core, an isolator core is arranged along the longitudinal center axis on which the conductors of the respective core abut.

6. High-speed data cable according to claim 5, wherein the isolator core is made from polypropylene, polyamide or polyethylene (each massive, foamed or as monofil).

7. High-speed data cable according to claim 5, wherein, in each core, the electric conductors with the insulating cover abut on the isolator core as well as on one another.

8. High-speed data cable according to claim 1, wherein the cores run in a twisted manner to one another.

9. High-speed data cable according to claim 1, wherein the conductive shielding is implemented of plastic-clad metal foil and/or wire mesh.

10. High-speed data cable according to claim 1, wherein the cores are respectively surrounded by the conductive shielding in pairs.

11. High-speed data cable according to claim 1, wherein four cores are arranged as star quad in a twisted manner.

12. High-speed data cable according to claim 1, wherein each core comprises 3 to 18 electric conductors.

13. High-speed data cable according to claim 1, wherein at least one core pair comprises differential wave impedance in the range of 50Ω to 300Ω.

14. Usage of a high-speed data cable according to claim 1 for balanced signal transmission.

15. System comprising:
a high-speed data cable according to claim 1, wherein the system is implemented to transmit a balanced signal via the high-speed data cable.
